(19) United States
(12) Patent Application Publication
(10) Pub. No.: US 2008/0159376 A1
(43) Pub. Date: Jul. 3, 2008

(54) Receiver with Decision-Feedback Fading Canceller

(75) Inventor: Hirohisa Yamaguchi, Tsukuba-City (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/967,255

(22) Filed: Dec. 30, 2007

Related U.S. Application Data
(60) Provisional application No. 60/883,011, filed on Dec. 31, 2006.

(51) Int. Cl. H04L 27/01

(52) U.S. Cl. 375/233

(57) ABSTRACT

A receiver that includes but is not limited to a demodulator, a channel equalizer coupled to the demodulator, a demapper coupled to the channel equalizer, a decision-feedback fade canceller (DFC) coupled to the channel equalizer, demodulator, and demapper, wherein an output of the DFC feeds back into the channel equalizer, and a squared summation circuit coupled to the output of the DFC.

This application claims priority under 35 USC §119(e)(1) of Provisional Application No. 60/883,011, filed Dec. 31, 2006, incorporated herein by reference.

### TECHNICAL FIELD OF THE INVENTION

The present disclosure generally relates to an Orthogonal Frequency Division Multiplexing (OFDM) Receiver using a decision-feedback fading canceller. More particularly, the present disclosure relates to OFDM receiver with an energy detector for alien signal detection.

### BACKGROUND OF THE INVENTION

Ultra Wide-Band (UWB) technology based on Multi-Band Orthogonal Frequency Division Multiplexing (MB-OFDM) permits short-distance, high-speed wireless communication between electronic devices. Examples of systems incorporating UWB technology may include a digital camera coupled to a printer without the use of a cable, wireless home theater systems, cable-free personal computer peripherals, and so on.

Unlike licensed wireless services with a dedicated frequency spectrum such as cellular phone, satellite television, earth surveillance satellite, weather radar, and airborne radar, UWB technology devices use an unlicensed spectrum spanning a frequency range from 3.1 GHz to 10.6 GHz. Due to the wide band nature of 7,500 MHz, the band overlaps with the bands used by current licensed wireless services and future wireless services. In order to prevent UWB technology devices from causing interference with other wireless services, the transmission power level of UWB devices operated in the United States is kept below −41.25 dBm/MHz. To further reduce interference with other wireless services, Japan, European Union, and other parts of the world may require UWB device transmission power levels be kept below −70 db/MHz as described in “Proposed Japan Spectrum Mask,” ECC TG3 document TG3#11_{—}17R0, September 2005, Copenhagen. Furthermore, UWB devices may have to detect the presence of other licensed and unlicensed wireless services and put in place an interference avoidance measure called Detection-and-Avoidance (DAA). However, because detection of an unknown signal is generally implemented as detection of signal power rise against existing noise power at the receiver, a low UWB transmission power level makes DAA difficult.

### SUMMARY OF THE INVENTION

In one aspect, a receiver apparatus, includes but is not limited to a demodulator; a channel equalizer operably coupleable to the demodulator; a demapper operably coupleable to the channel equalizer; a Decision-feedback Fade Canceller (DFC) operably coupleable to the channel equalizer, demodulator, and demapper, wherein an output of the DFC feeds back into the channel equalizer; and a squared summation circuit operably coupleable to the output of the DFC.

In one aspect, a method includes but is not limited to receiving one or more signals; converting the signals to digital format; demodulating the signals; performing feedback fading cancellation of the demodulated signals; and summing power of the signals to detect if more than one signal is present.

In one aspect, a method for detecting a first signal in presence of a second signal includes but is not limited to receiving the first signal and the second signal; demodulating the signals; determining a first average power of the demodulated signals; performing feedback fading cancellation of the demodulated signals; determining a second average power of the signals after performing feedback fading cancellation of the signals; comparing the first average power to the second average power to determine a third average power; and detecting the presence of the first signal when the third average power exceeds a threshold.

In one or more various aspects, related systems include but are not limited to circuitry, programming, electro-mechanical devices, or optical devices for effecting the herein-referenced method aspects; the circuitry, programming, electromechanical devices, or optical devices can be virtually any combination of hardware, software, or firmware configured to effect the herein-referenced method aspects depending upon the design choices of the designer.

In addition to the foregoing, various other method, device, and system aspects are set forth and described in the teachings such as the text (e.g., claims and detailed description) and drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices, processes, or other subject matter described herein will become apparent in the teachings set forth herein.

### BRIEF DESCRIPTION OF THE DRAWINGS

FIG. 1 shows a simplified block diagram of an MB-OFDM receiver;

FIG. 2 depicts the UWB band divided into fourteen 528 MHz;

FIG. 3 is a graph showing UWB signal mingling with WiMAX signal;

FIG. 4(a) is a time domain plot of the WiMAX signal shown in FIG. 3;

FIG. 4(b) is a time domain plot of the MB-OFDM signal shown in FIG. 3;

FIG. 5(a) shows transmitting UWB device at long distance from receiving UWB device;

FIG. 5(b) shows transmitting UWB device at short distance from receiving UWB device;

FIG. 6 shows detection of an alien signal by MB-OFDM receiver;

FIG. 7 shows in accordance with some embodiments of the invention, an MB-OFDM receiver with Decision-feedback Fading Cancellation (DFC);

FIG. 8(a) shows interspersed signals at UWB receiver when UWB receiver and transmitter are close;

FIG. 8(b) shows average power of signals from FIG. 8a using MB-OFDM receiver of FIG. 6;

FIG. 8(c) shows average power of signals from FIG. 8a using MB-OFDM receiver with DFC of FIG. 7;

FIG. 9(a) shows average power of MB-OFDM signals with degradation of channel equalization caused by noise for MB-OFDM receiver with DFC of FIG. 7 when UWB receiver and transmitter are far apart;

FIG. 9(b) shows average power of signals using MB-OFDM receiver with DFC of FIG. 7 when UWB receiver and transmitter are far apart;

FIG. 10(a) is a graph of detection decision for MB-OFDM signal with AWGN component without fading effect; and

FIG. 10(b) is a graph of detection decision for MB-OFDM signal with fading effect.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” or “coupleable” is intended to mean either an indirect or direct electrical or wireless connection. Thus, if a first device couples to a second device, that connection may be through a direct electrical or wireless connection, or through an indirect electrical or wireless connection via other devices and connections.

### DETAILED DESCRIPTION OF EMBODIMENTS

A technique to achieve detection of an alien signal at a Ultra Wide-Band (UWB) technology device receiver is based on Decision-feedback Fading Cancellation (DFC). By incorporating DFC, detection of an alien signal at the signal power level of as low as −95 dBm/MHz becomes possible without increased hardware complexity.

In Multi-Band Orthogonal Frequency Division Multiplexing (MB-OFDM), each tone (sub-carrier) may be modulated by quaternary phase shift keying (QPSK). When a sub-carrier is modulated, its bandwidth expands from a single frequency of zero bandwidth to a non-zero bandwidth. In MB-OFDM, 128 sub-carriers are modulated into a bandwidth of 4.125 MHz each, which constitute a total bandwidth of 128×4.125=528 MHz. MB-OFDM and QPSK are described in the following books: 1. Proakis, J. G., Digital Communications, McGraw-Hill Publishing, 1989; and 2. Peterson, Ziemer and Borth, Introduction to Spread Spectrum Communications, Prentice Hall, 1995, both of which are incorporated herein by reference.

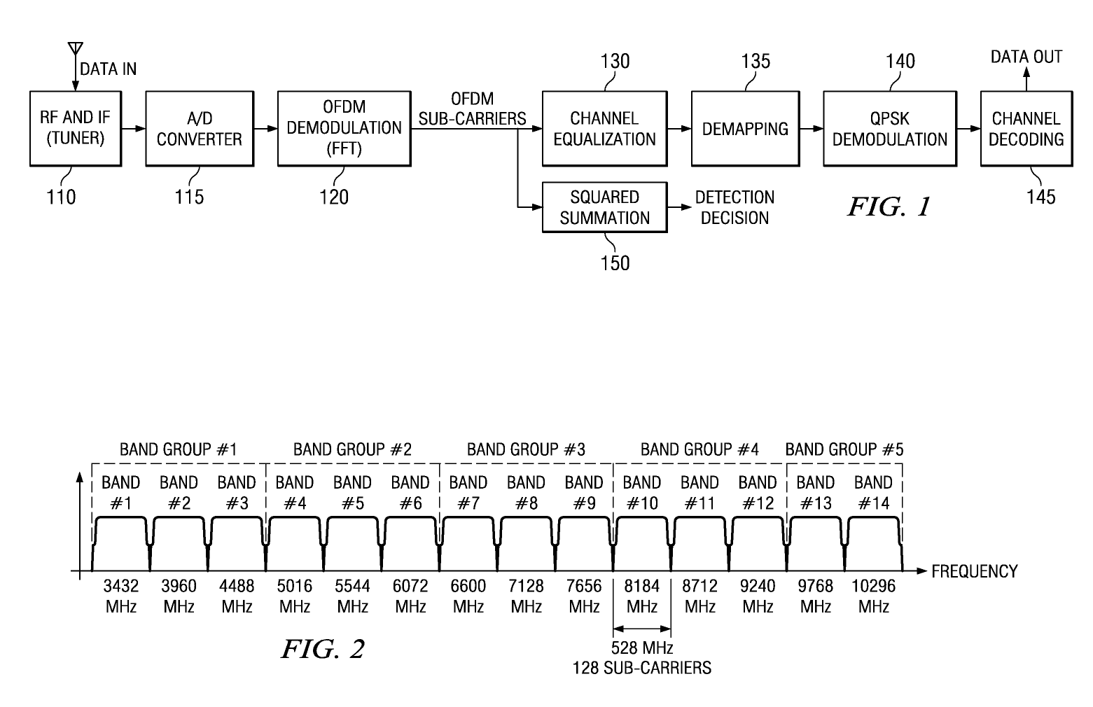

MB-OFDM's spread spectrum technique distributes the data over a large number of sub-carriers that are spread apart at precise frequencies. The spacing provides the “orthogonality” in this technique that prevents the demodulators from seeing other frequencies than their own. The MB-OFDM technique relies on the orthogonality properties of the Fast Fourier transform (FFT) and the inverse fast Fourier transform (IFFT) to eliminate interference between carriers. At the transmitter, the precise setting of the carrier frequencies is performed by the IFFT. The data is encoded into constellation points by multiple (one for each sub-carrier) constellation encoders. The complex values of the constellation encoder outputs are the inputs to the IFFT. For wireless transmission, the outputs of the IFFT are converted to an analog waveform, upconverted to a radio frequency, amplified, and transmitted. At the receiver, as shown in FIG. 1, the reverse process is performed. After reception and amplification by RF/IF tuner 110, the received signal is down converted to a band suitable for analog to digital conversion, digitized in A/D converter 115, and processed by a FFT to recover the sub-carriers in OFDM Demodulator 120. After the sub-carriers are equalized in channel equalizer 130 and demapping occurs 135, the sub-carriers are then demodulated in multiple constellation decoders (one for each sub-carrier) in QPSK demodulator 140 and decoded by channel decoder 145, recovering the original data. Since an IFFT is used to combine the sub-carriers at the transmitter and a corresponding FFT is used to separate the sub-carriers at the receiver, the process has potentially zero intercarrier interference.

For detection of an alien signal, squared summation 150 of the signal power of OFDM sub-carriers from OFDM Demodulator 120 is summed over a pre-defined number of OFDM symbols. An alien signal is detected by an increase of the signal power at one or a group of sub-carriers, described in detail below. In case of the QPSK modulation for MB-OFDM, each sub-carrier carries the same power. Hence, detection of an alien signal by observing the signal power is an effective approach.

As shown in FIG. 2, in MB-OFDM, the entire UWB band is divided into fourteen 528 MHz bands. In actual operation, the transmitter and the receiver device may synchronously switch between communication bands in a band group. For example, the three lowest frequency bands in FIG. 2 are called Band Group #1-the transmitter and the receiver device may switch between Band #1, Band #2 and Band #3 in sequence. This may reduce the interference between two different pairs of transmitters and receivers that try to use the same band group.

When an alien wireless receiver is operating within a band used by a UWB technology device, the alien wireless receiver reception may be hampered by the transmitted MB-OFDM signal in UWB band. As an example, we consider a WiMAX wireless device of signal bandwidth 5 MHz in the following discussion. Those of skill in the art recognize that use of a WiMAX signal in this disclosure is for illustrative purposes only and may be replaced by any interfering signal. Thus, the embodiments of the disclosed apparatus and methods are general and should not be limited to the WiMAX signal.

Depending on country and region of operation, the bandwidth of a WiMAX signal may be between 1.75 MHz to 30 MHz. WiMAX signal frequency band of operation may be between 3.5 GHz to 4 GHz and depends on country and region of operation. As mentioned above, a WiMAX system of signal bandwidth 5 MHz that operates at 4 GHz is used as an example in this disclosure.

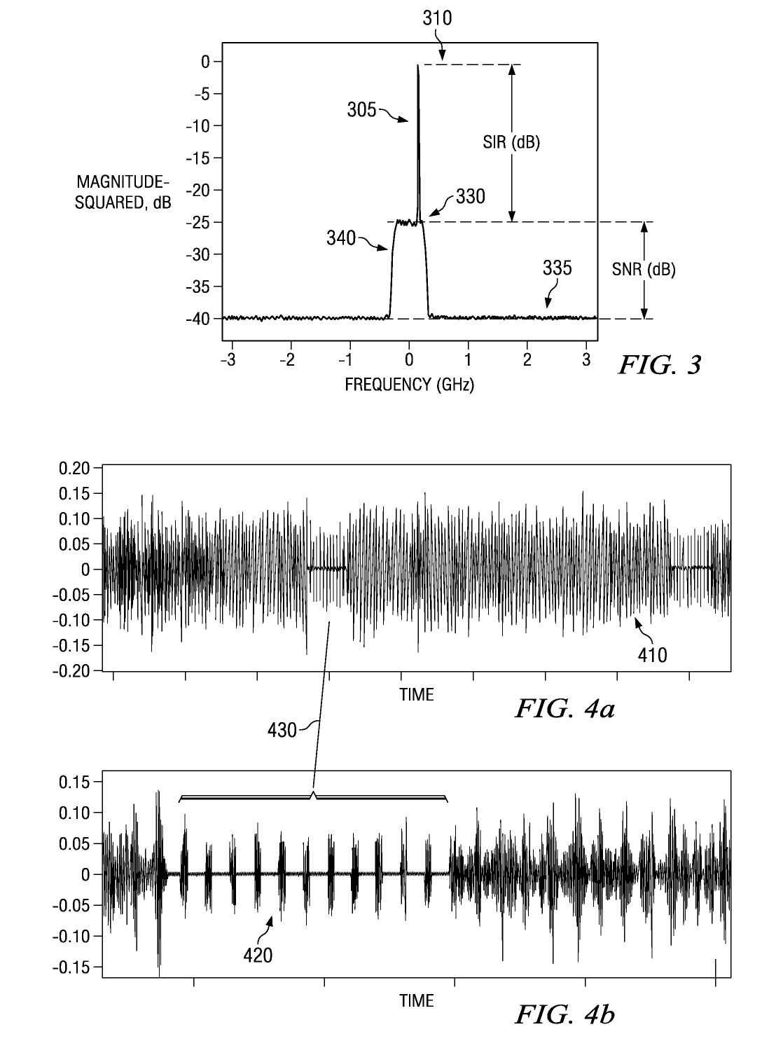

When a UWB device receives a transmitted MB-OFDM signal in Band #2 at 3.96 GHz as shown in FIG. 2, a WiMAX signal transmitted at 4 GHz may mingle with the MB-OFDM signal as shown in FIG. 3. The MB-OFDM and WiMAX signal are frequency shifted in FIG. 3 so that zero GHz in the figure corresponds to 3.96 GHz. In FIG. 3, the WiMAX signal 305 is stronger than the received MB-OFDM signal 340. Because the bandwidth of the WiMAX signal is 5 MHz, its spectrum appears at a single MB-OFDM sub-carrier position. Over a time period, the WiMAX signal can be observed in multiple MB-OFDM sub-carriers around the WiMAX frequency of 4 GHz. If the WiMAX signal is weaker than the received MB-OFDM signal, the WiMAX signal may be hard to detect as it would be covered by the MB-OFDM signal of FIG. 3.

Turning now to FIG. 4(a) and FIG. 4(b), MB-OFDM signal and WiMAX signal of FIG. 3 are plotted in time domain graph of amplitude vs. time. FIG. 4(a) shows WiMAX signal 410 in time domain and FIG. 4(b) shows MB-OFDM signal 420 in time domain. When the WiMAX signal is stronger than the received MB-OFDM signal, the MB-OFDM signal is buried within the WiMAX signal. Thus, detection of the WiMAX signal is possible when the signal is stronger than the received MB-OFDM signal. When a WiMAX signal is weaker as shown in time slice 430, a large number of received MB-OFDM symbols need to be added before detection becomes possible in high accuracy.

Regardless of the strength of a WiMAX signal, it can be observed as a rise in the received sub-carrier power. As described above, each sub-carrier is not correlated between subsequently transmitted MB-OFDM symbols, so it can be regarded as Additive White Gaussian Noise (AWGN) in which samples are statistically independent of each other and stable in power level. Thus, when power level is determined from measured results in other frequencies, or taking a minimum power level over a long observation time, or some other means, a significant rise in the sub-carrier power level may suggest the presence of an alien signal. As shown in FIG. 4 in time slice 430, one WiMAX symbol may be as long as 90 MB-OFDM symbols. This leads to the accumulation of sub-carrier power over 90 MB-OFDM symbols. This characteristic is common with most other alien signals, not specific to WiMAX alone.

Detection of an alien signal by a change of the signal power is generally called non-coherent detection for unknown signals. However, the approach described above for detection of an alien signal, fails, without exception, when the received MB-OFDM signal is strong, and undergoes a fading. Fading refers to the distortion that a carrier-modulated communication signal experiences over certain propagation media. Fading may be caused by multipath propagation and is sometimes referred to as multipath induced fading. In multipath induced fading, the presence of reflectors in the environment surrounding a transmitter and receiver create multiple paths that a transmitted signal can traverse. As a result, the receiver sees the superposition of multiple copies of the transmitted signal, each traversing a different path. Each signal copy will experienced differences in attenuation, delay and phase shift while travelling from the transmitter to the receiver. This can result in either constructive or destructive interference, amplifying or attenuating the signal power seen at the receiver. Strong destructive interference may be referred to as a deep fade and may result in temporary failure of communication due to a drop in the channel signal-to-noise ratio.

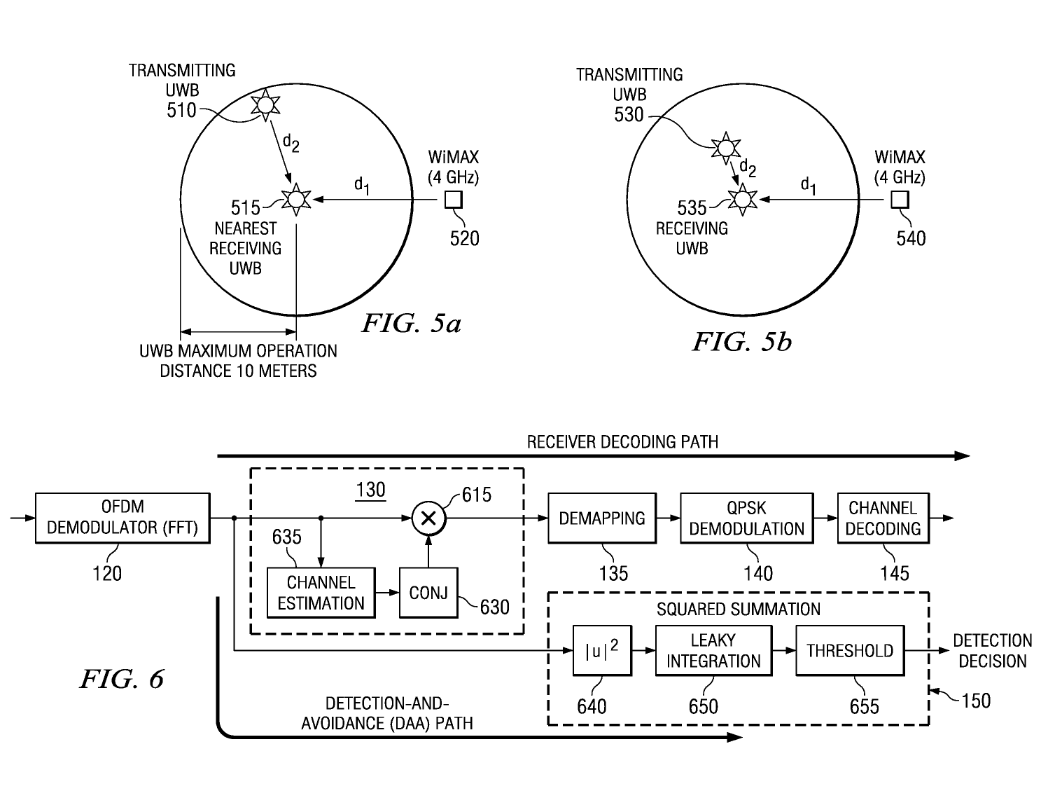

FIG. 5a and FIG. 5b illustrate the limited range of operation of UWB technology devices. UWB technology devices have a limited range due to a limit on the maximum emission power of these devices. The maximum range of a typical UWB device may be a radius of 10 meters as shown in FIG. 5a. When the transmitting UWB device 510 is distance d₂=10 meters away, the MB-OFDM signal power of the UWB device 510 drops close to the noise level at the nearest UWB receiver 515. Detection of a relatively stronger WiMAX signal a distance d₁ from transmitting WiMAX device 520 is possible. Thus, the non-coherent detection technique described above could detect the presence of the WiMAX signal interspersed with the MB-OFDM signal.

Turning now to FIG. 5(b), a transmitting UWB device 530 is distance d₂<<10 meters from receiving UWB device 535. Detection of a signal transmitting from WiMAX device 540 a distance d₁ from UWB device 535 is interfered by the strong MB-OFDM signal from UWB device 530. Furthermore, when the channel suffers from fading in selective frequencies, the received MB-OFDM signal is not uniform in power over the received UWB band, and it may be difficult to identify if a power increase is due to the existence of an alien signal or due to fading.

Various companies have reported that if the UWB transmitter is 1 meter away, detection of a WiMAX signal may be possible when the received WiMAX signal power is greater than −77 dBm/MHz. UWB devices may assume connection of much shorter distance, and WiMAX industry alliance requires detection of WiMAX devices below −85 dBm/MHz. Thus, detection of an alien signal is difficult if the alien signal is interspersed with a strong signal transmitted by a nearby UWB device and because of effect of fading on the communication channel.

FIG. 6 shows MB-OFDM receiver of FIG. 1 in more detail to detect an alien signal. The output of FFT in OFDM demodulator 120 is multiplied with the conjugate of the channel estimation for channel equalization. This output is demapped in Demapper 135, QPSK demodulated 140 and converted into a fundamental binary sequence, which is further input to the Channel Decoder 145 that is a Viterbi decoder.

Detection of an alien signal along DAA path may be accomplished by Squared Summation 150 of the FFT outputs from OFDM Demodulator 120. The FFT outputs are non-coherently accumulated and checked for increase of the power level due to an alien signal. Thus, in some embodiments, the detection logic for detecting an alien signal may include summation block 640 for non-coherent accumulation of the FFT outputs. Leaky integrator 650 performs a running average on the non-coherently accumulated output from 640 and when the value of the running average exceeds a pre-defined threshold 655 at some OFDM sub-carrier, detection decision is turned on.

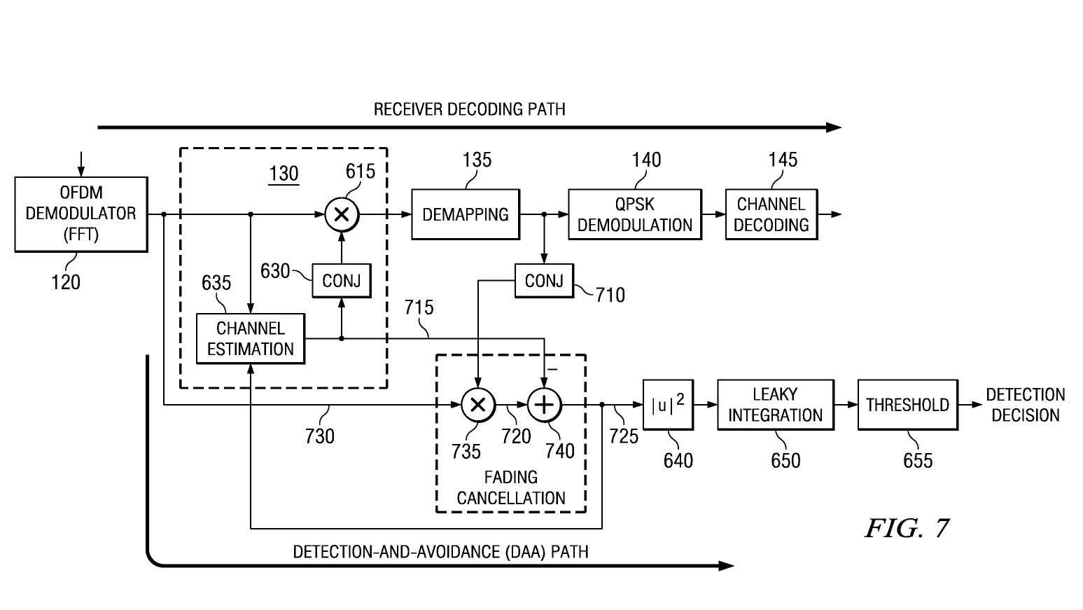

As described above, when a UWB device transmitter and a UWB device receiver are close together and the signal at UWB receiver suffers from fading effect, the channel-equalized output has unequal noise power in the sub-carriers of UWB band, making measurement of the power due to an alien signal difficult. Thus, in accordance with some embodiments of the invention, FIG. 7 shows an MB-OFDM receiver with Decision-feedback Fading Cancellation (DFC) for detection of an alien signal. The output from Demapper 135 is conjugate-multiplied with the OFDM Demodulator 120 FFT output at multiplier 735. The output of the multiplier at position 720 is subtracted from the output 715 of Channel Estimator 635 at subtractor 740. The output of the subtractor at position 725 is input to the non-coherent detection logic as described above, and at the same time, the subtractor output is fed back to Channel Estimator 635 to fine correct the channel estimation signal. Addition of the fed back signal to the original channel estimation signal suffices for fine correction of channel estimation signal.

At position 725, the signal obtained is the original OFDM Demodulator 120 FFT output that has the MB-OFDM signal received from the UWB device transmitter under a fading condition removed. Because of errors in channel estimation, one or more sub-carriers in the UWB band may cause an increase in the power of the signal at position 725, making high-precision detection of the alien signal less accurate. Thus, the signal at position 725 may include a noise component and a channel estimation error component. The AWGN noise component, when averaged in Leaky Integrator 650, becomes zero. However, the signal component caused by channel estimation error, when averaged in Leaky Integrator 650, results in a non-zero value that corresponds to the error from channel estimation. Thus, by feeding back the signal at position 725 to Channel Estimator 635, the estimation error may be corrected. Correction of the channel estimation error and averaging out of the noise error to a zero value flattens out the frequency spectrum of the signal at position 725, allowing accurate detection of the alien signal.

Use of the UWB Decision-feedback Fading Cancellation (DFC) receiver shown in FIG. 7 allows detection of an alien signal with UWB transmitter located close to the UWB receiver and the signal at UWB receiver suffering from fading effect. If the UWB transmitter is located a large distance from the UWB receiver as shown in FIG. 5a, channel equalization of the signal from OFDM Demodulator 120 in Channel Equalizer 130 at position 715 as shown in FIG. 7 may cause the signal to become noisy from the weak signal and fading effect. Feed back of the signal at position 725 to Channel Estimator 635 in Channel Equalizer 130 increases the noise in the signal at position 715. The detection decision in FIG. 7 may be falsely triggered because of the increased noise with no alien signal present. Thus, in some embodiments of the invention, allowing the use of the UWB receiver shown in FIG. 6 that does not feedback the signal at position 725 to Channel Estimator 635 would result in a more accurate detection decision for determination of the presence of an alien signal. Determining the criteria needed to switch between the UWB receivers shown in FIG. 6 and FIG. 7 for an accurate detection decision based on the distance between the UWB transmitter and UWB receiver is described in more detail below.

Accuracy of UWB receivers shown in FIG. 6 and FIG. 7 for detection of alien signal is affected by the Signal-to-Interference signal Ratio (SIR) and Signal-to-Noise Ratio (SNR) that are shown in FIG. 3. SIR is the ratio of the received alien signal power (WiMAX signal in FIG. 3) 310, to the received MB-OFDM signal power 330 at the UWB receiver. SNR is the ratio of the received MB-OFDM signal power 330 to the receiver noise power 335 at UWB receiver.

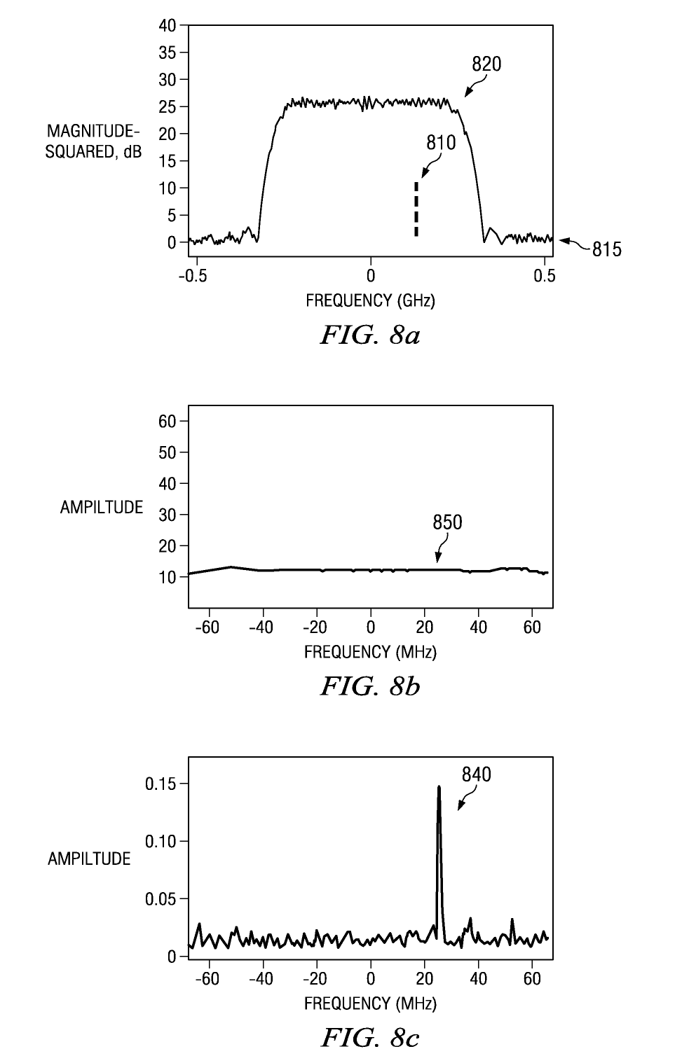

Turning now to FIG. 8(a), interspersed MB-OFDM signal 820, WiMAX signal 810 and UWB receiver white noise 815 for UWB receiver and UWB transmitter close together are shown. A conservative assumption for UWB receiver noise floor level 815 may be specified as −98 dBm/MHz for UWB devices sold as commercial products. As discussed above, the received WiMAX signal may be −87 dBm/MHz, its magnitude-squared is 11 dB 810 above the noise floor as shown in FIG. 8a. If the MB-OFDM signal is received at −72 dBm/MHz 820 as shown in FIG. 8a, the WiMAX signal is completely buried in the MB-OFDM signal and is not visible. In such a case, the WiMAX signal is much weaker than the MB-OFDM signal as shown in FIG. 8a. Thus, as shown in FIG. 8b, it is not possible to detect the WiMAX signal using the UWB receiver of FIG. 6 without DFC; the MB-OFDM signal is strong and interferes with the detection of other signals. However, as shown in FIG. 8c, when the UWB receiver of FIG. 7 with DFC is used, the interference from the received MB-OFDM signal is removed and the alien WiMAX signal becomes detectable. As described above, UWB receiver with DFC of FIG. 7 may also detect the alien signal when the fading effect is present at UWB receiver.

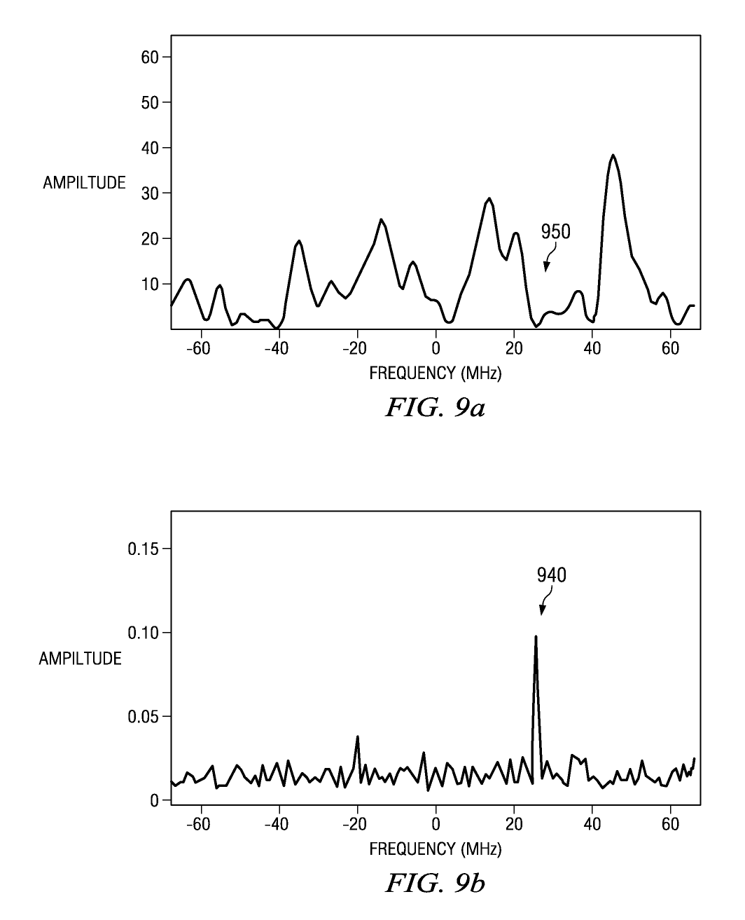

In the scenario of the UWB receiver and UWB transmitter located a distance apart as shown in FIG. 5a, output from Channel Equalization 130 may become noisy when the MB-OFDM signal received at UWB receiver 515 becomes weak. Under this condition, the detection results become as shown in FIG. 9a and FIG. 9b. Using UWB receiver with DFC shown in FIG. 7, the alien signal is visible as shown in FIG. 9b but significantly degraded compared to FIG. 8c for a strong MB-OFDM signal. Thus, UWB receiver with DFC shown in FIG. 7 is affected by degradation of channel equalization caused by noise as shown in FIG. 9a when the MB-OFDM signal received at UWB receiver is weak. In accordance with some embodiments of the invention, switching the UWB receiver from UWB receiver with DFC (FIG. 7) back to UWB receiver without DFC (FIG. 6) when the channel estimation becomes noisy. Comparison of the average sub-carrier power determined at output of Leaky Integrator 650 of UWB receiver in FIG. 6 with UWB receiver in FIG. 7 may be used to select the appropriate UWB receiver for alien signal detection. The average sub-carrier power from UWB receiver without DFC shown in FIG. 8b for strong MB-OFDM signal is around 62 dBm. The average sub-carrier power from UWB receiver with DFC shown in FIG. 9a because of weak MB-OFDM signal resulting in channel equalization becoming noisy is around 700 dBm. Thus, a pre-defined threshold between 62 dBm and 700 dBm can be determined to switch between the DFC receiver of FIG. 7 and non-DFC receiver of FIG. 6. By raising the value of pre-defined threshold, correct detection probability increases but also lowers the detection success probability. Detection success probability is defined as the ratio of the detection decision alarm time and the alien signal symbol length. A WiMAX signal has an alien signal symbol length of 101 microseconds. The pre-defined threshold is fixed at a level that a correct detection decision is achieved over 90% of the time.

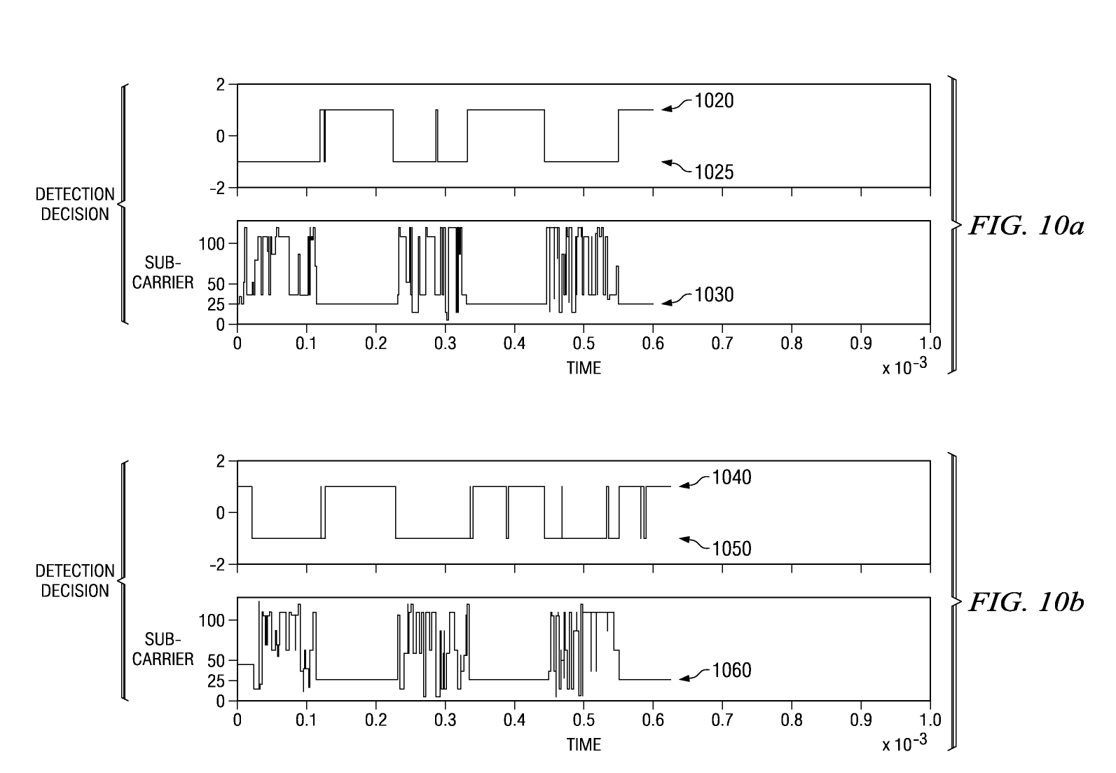

Finally, as shown in FIG. 10a and FIG. 10b, a criterion to determine whether the detected power spike is due to an alien signal is shown. In general, as described above, the detection failure probability is required to be less than 10% and the pre-defined threshold is set accordingly. As shown in FIG. 10a and FIG. 10b and described above, when the average power level exceeds a threshold 655 shown in FIG. 6 or FIG. 7, detection decision is turned ON. FIG. 10a shows MB-OFDM signal with AWGN component without fading effect, detection decision is ON 1020 when it is above the threshold and OFF 1025 when it is below the threshold. Detection decision is ON 1020 and correct detection occurs for sub-carrier 25 1030. FIG. 10b shows MB-OFDM signal with fading effect, detection decision is ON 1040 when it is above the threshold and OFF 1050 when it is below the threshold. Detection decision is ON 1040 and correct detection occurs for sub-carrier 25 1060.

Comparison of the UWB receiver without DFC in FIG. 6 and UWB receiver with DFC in FIG. 7 has been simulated with the thresholding rules described above and using a WiMAX signal as the alien signal. The simulation assumes that the received MB-OFDM signal power is a function of the distance from the transmitting UWB device.

From the simulation results, the UWB receiver without DFC, without exception, fails to detect the alien signal when the UWB transmitter is located close to the UWB receiver. The UWB receiver with DFC in FIG. 7 achieves nearly 100% detection accuracy for the WiMAX signal power level down to −90 dBm/MHz. Performance of the UWB receiver with DFC begins to degrade as the WiMAX signal power level drops below −95 dBm/MHz and for the UWB transmitter/receiver distance of around 4 meters. This may be solved by increasing the number of the square-summed OFDM symbols-the number of the square-summed symbols may be doubled from 60. Thus, simulations suggest that detection of a WiMAX signal is possible down to −95 dBm/MHz when as many as 120 OFDM symbols are used. Further increase in the OFDM symbols may be effective for some applications, but details are implementation dependent.

For practical implementation of UWB receivers shown in FIG. 6 and FIG. 7, detection decision should be run continuously in real-time. When the threshold as shown in FIG. 10a and FIG. 10b is exceeded, detection of an alien signal in the specific sub-carrier frequency is confirmed. When an alien signal occupies a wider bandwidth, detection result spreads over a group of contiguous OFDM sub-carriers, and additional detection logic would be necessary to achieve a robust detection.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A receiver apparatus, comprising:
a demodulator;
a channel equalizer operably coupleable to the demodulator;
a demapper operably coupleable to the channel equalizer;
a decision-feedback fade canceller (DFC) operably coupleable to the channel equalizer, demodulator, and demapper, wherein an output of the DFC feeds back into the channel equalizer; and
a squared summation circuit operably coupleable to the output of the DFC.

2. The apparatus of claim 1, wherein the demodulator is an Orthogonal Frequency Division Multiplexing (OFDM) demodulator.

3. The apparatus of claim 1, wherein the demodulator includes a Fast Fourier Transform (FFT) circuit.

4. The apparatus of claim 1, wherein the squared summation circuit generates an alien signal detection decision.

5. The apparatus of claim 4, wherein the squared summation circuit further comprises:
an input operably coupleable to the output of the DFC;
a summation circuit receiving the input, wherein the summation circuit includes an output;
an integrator receiving the output of the summation circuit, wherein the integrator includes an output; and
a threshold circuit receiving the output of the integrator, wherein the integrator includes an output that is the alien signal detection decision.

6. The apparatus of claim 1, wherein the DFC further comprises:
a first DFC input operably coupleable to an output of the demapper;
a first conjugator receiving the first DFC input;
a first multiplier operably coupleable to the first conjugator;
a second DFC input operably coupleable to the first multiplier, wherein the second DFC input is operably coupleable to an output of the demodulator, wherein the first conjugator includes an output, wherein the first multiplier multiplies the output of the first conjugator with the second DFC input, wherein the first multiplier includes an output;
a subtractor operably coupleable to the first multiplier; and
a third DFC input operably coupleable to the subtractor, wherein the third DFC input is operably coupleable to an output of the channel equalizer, wherein the subtractor subtracts the output of the first multiplier from the third DFC input, wherein the subtractor includes an output that is the output of the DFC.

7. The apparatus of claim 6, wherein the channel equalizer further comprises:
a first channel equalizer input operably coupleable to the output of the demodulator;
a channel estimator receiving the first channel equalizer input, wherein the channel estimator includes an output that is the third DFC input;
a second channel equalizer input operably coupleable to the channel estimator, wherein the second channel equalizer input is operably coupleable to the output of the DFC;
a second conjugator receiving the output of the channel estimator, wherein the second conjugator includes an output; and
a second multiplier receiving the output of the second conjugator, wherein the second multiplier receives the first channel equalizer input, wherein the second multiplier multiplies the output of the second conjugator with the first channel equalizer input, wherein the second multiplier includes an output that is a channel equalizer output to the demapper.

8. The apparatus of claim 1, comprising:
a quaternary phase shift keying (QPSK) demodulator operably coupleable to the demapper; and
a channel decoder operably coupleable to the QPSK demodulator, wherein the channel decoder is a Viterbi decoder.

9. A method, comprising:
receiving one or more signals;
converting the signals to digital format;
demodulating the signals;
performing feedback fading cancellation of the demodulated signals; and
summing power of the signals to detect if more than one signal is present.

10. The method of claim 9, wherein the signals are at the same frequencies.

11. The method of claim 9, further comprising:
equalizing the signals, wherein demodulating the signals comprises performing Fast Fourier Transform (FFT) demodulation of the signals;
demapping the equalized signals;
performing a quaternary phase shift keying (QPSK) demodulation of the signals; and
decoding the signals.

12. The method of claim 11, wherein equalizing the signals comprises:
performing channel estimation on the FFT demodulated signals;
conjugating the channel estimated signals; and
multiplying the FFT demodulated signals with the conjugated signals.

13. The method of claim 11, wherein performing feedback fading cancellation comprises:
conjugating the demapped signals;
multiplying the conjugated signals with the FFT demodulated signals;
subtracting the multiplied signals from the equalized signals; and
feeding back the subtracted signals to equalize the signals.

14. The method of claim 9, wherein summing the power of the signals comprises:
accumulating the signals;
performing a running average on the accumulated signals; and
detecting the presence of more than one signal when the running average exceeds a threshold.

15. A method for detecting a first signal in presence of a second signal, comprising:
receiving the first signal and the second signal;
demodulating the signals;
determining a first average power of the demodulated signals;
performing feedback fading cancellation of the demodulated signals;
determining a second average power of the signals after performing feedback fading cancellation of the signals;
comparing the first average power to the second average power to determine a third average power; and
detecting the presence of the first signal when the third average power exceeds a threshold.

16. The method of claim 15, wherein the first signal and the second signal are at the same frequencies.

17. The method of claim 15, wherein comparing the first average power to the second average power comprises:
setting the third average power of the signals to the second average power if first average power and second average power is less than a pre-set threshold; and
setting the third average power of the signals to the first average power if first average power and second average power is greater than the pre-set threshold.

18. The method of claim 15, wherein determining the first average power of the demodulated signals comprises:
accumulating the signals; and
performing a running average on the accumulated signals.

19. The method of claim 15, further comprising:
equalizing the signals, wherein demodulating the signals comprises performing Fast Fourier Transform (FFT) demodulation of the signals;
demapping the equalized signals;
performing a quaternary phase shift keying (QPSK) demodulation of the signals; and
decoding the signals.

20. The method of claim 19, wherein performing feedback fading cancellation comprises:
conjugating the demapped signals;
multiplying the conjugated signals with the FFT demodulated signals;
subtracting the multiplied signals from the equalized signals; and
feeding back the subtracted signals to equalize the signals.
